(19) United States
(12) Patent Application Publication
(10) Pub. No.: US 2026/0025418 A1
(43) Pub. Date: Jan. 22, 2026

(54) METHOD AND SYSTEM FOR PRIORITY OF IMS DATA CHANNEL

(71) Applicant: Verizon Patent and Licensing Inc., Basking Ridge, NJ (US)

(72) Inventors: Kashif Khan, Keller, TX (US); John Cao Vinh Nguyen, Trophy Club, TX (US); Daniel L. Walker, Wall, NJ (US); Steve L. Padilla, Lewisville, TX (US); Ronald E. Collier, II, Arlington, TX (US)

(21) Appl. No.: 18/778,232

(22) Filed: Jul. 19, 2024

(51) Int. Cl. H04L 65/1069; H04L 65/1016; H04L 65/1045; H04L 65/1104

(52) U.S. Cl. CPC H04L 65/1069; H04L 65/1016; H04L 65/1045; H04L 65/1104

(57) ABSTRACT

A method, an end device, and a non-transitory computer-readable storage medium are described in relation to an IMS data channel priority service. The IMS data channel priority service may include assigning a priority to resources for a data channel based on a media feature tag included in a request from an end device. The IMS data channel priority service may include a data channel priority value in messages exchanged in the IMS network that establish the IMS data channel. The IMS data channel priority service may select a data channel control policy based on the data channel priority value.

### BACKGROUND

An Internet Protocol (IP) Multimedia Subsystem (IMS) network is a standardized architectural framework for delivering IP multimedia services, such as voice, video, messaging, data services, among other types of services, applications, and so forth.

### BRIEF DESCRIPTION OF THE DRAWINGS

FIG. 1 is a diagram illustrating an exemplary environment in which an exemplary embodiment of a IMS data channel priority service may be implemented;

FIG. 2 is a diagram illustrating an exemplary IMS environment that provides an exemplary embodiment of the IMS data channel priority service;

FIGS. 3A-3C are diagrams illustrating an exemplary messaging diagram indicative of an exemplary embodiment of the IMS data channel priority service;

FIG. 3D is a diagram illustrating exemplary data channel priority information;

FIG. 4 is a diagram illustrating exemplary components of a device that may correspond to one or more of the devices illustrated and described herein; and

FIG. 5 is a flow diagram illustrating an exemplary process of an exemplary embodiment of the IMS data channel priority service.

### DETAILED DESCRIPTION

The following detailed description refers to the accompanying drawings. The same reference numbers in different drawings may identify the same or similar elements. Also, the following detailed description does not limit the invention.

An IMS data channel is an additional data channel media type that may be used in parallel with other media types, such as voice and video in the context of overall multimedia telephony service provided by an IMS network. The IMS data channel provides the ability to establish a real-time communication path between endpoints to exchange any form of data information, so long as the capabilities of the endpoints are compatible and agreed upon. The IMS data channel may be used by applications pertaining to connected vehicles, clinical remote monitoring, gaming, and other types of applications.

Currently, the IMS network sets up and maintains data channels without distinction among different applications. For example, the IMS network does not afford different levels of priority to applications delivered via IMS data channels. This approach can be problematic given the differences among the applications and when access to resources may be limited, such as during a congestive state. For example, a critical application may have no priority to resources of the IMS network relative to a non-critical application.

According to exemplary embodiments, an IMS data channel priority service is described. According to an exemplary embodiment, the IMS data channel priority service may be provided by an IMS network. According to an exemplary embodiment, the IMS data channel priority service may include assigning a priority level to each IMS data channel.

According to an exemplary embodiment, the IMS network may receive a Session Initiation Protocol (SIP) INVITE (e.g., initial or re-INVITE), which includes a media feature tag, to initiate an IMS session. The IMS network may identify the media feature tag and select a data channel priority value, which indicates a data channel priority, based on the media feature tag. The IMS network may insert the data channel priority value in the SIP INVITE. The IMS network may afford priority to the data channel and access and use of the network resources that support the data channel.

According to an exemplary embodiment, the IMS data channel priority service may provide the IMS data channel service profile to an IMS application server (AS) during a third-party registration. For example, the priority level may be indicated in an IMS data channel service profile, as described herein.

According to an exemplary embodiment, the IMS network may include a modified network device (e.g., relative to current network standards for IMS networks provided by network standardizing bodies, such as Third Generation Partnership Project (3GPP), 3GPP2, International Telecommunication Union (ITU), European Telecommunications Standards Institute (ETSI), GSM Association (GSMA), or the like) that may setup an IMS data channel based on the IMS data channel service profile. For example, the modified network device may include a modified Data Channel Signaling Function (DCSF) that includes providing an exemplary embodiment of the IMS data channel priority service, as described herein. According to other examples, the modified network device may include other types of network devices of an IMS network, as described herein (e.g., a Call Session Control Function (CSCF), etc.).

According to an exemplary embodiment, based on the load and available resources (e.g., associated with a Data Channel Media Function (DCMF)) and the priority level of the data channel, the DCSF may determine whether or not a data channel request will be accepted or not. For example, the priority level may impact the handling of SIP signaling associated with an application for networks devices of the IMS network during different states of the IMS network (e.g., congestive state, non-congestive state, etc.).

In view of the foregoing, the IMS data channel priority service may improve network and end device performance for applications that are delivered via IMS data channels based on the assignment of different priority levels. For example, higher priority IMS data channels that may support critical applications or other types of applications of importance, may be afforded higher priority to resources of the IMS network and probability of setup and maintenance of IMS sessions relative to lower priority IMS data channels and applications.

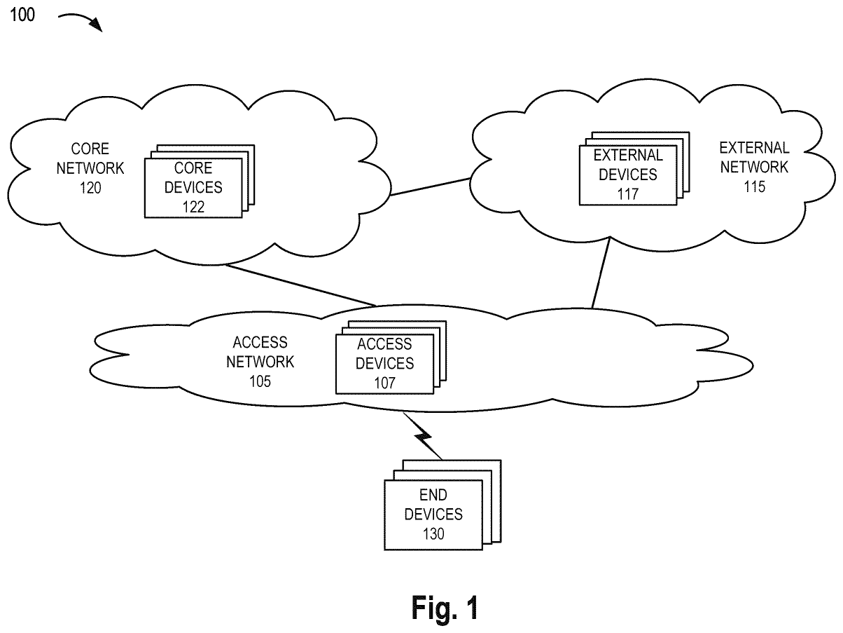

FIG. 1 is a diagram illustrating an exemplary environment 100 in which an exemplary embodiment of the IMS data channel priority service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the IMS data channel priority service may use at least one of these planes of communication.

Access network 105 may include one or multiple networks of one or multiple types and technologies. For example, access network 105 may be implemented to include a 5G RAN, a future generation RAN (e.g., 6G RAN, a 7G RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a gNB, an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a hotspot device, a fixed wireless access customer premises equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

External network 115 may include one or multiple networks of one or multiple types and technologies that provide an end device application service. For example, external network 115 may be implemented using one or multiple technologies including network function virtualization (NFV), SDN, cloud computing, Infrastructure-as-a-Service (IaaS), Platform-as-a-Service (PaaS), Software-as-a-Service (SaaS), or another type of network technology.

According to an exemplary embodiment, external network 115 includes an IMS network that provides an exemplary embodiment of the IMS data channel priority service. External network 115 may be implemented to include a cloud network, a private network, a public network, a multi-access edge computing (MEC) network, a fog network, the Internet, a packet data network (PDN), a service provider network, the World Wide Web (WWW), a Rich Communication Service (RCS) network, a virtual network, a packet-switched network, a data center, a data network, or other type of application service layer network that may provide access to and may host an end device application service.

Depending on the implementation, external network 115 may include various network devices such as external devices 117. According to an exemplary embodiment, external devices 117 of the IMS network may include a Proxy-CSCF (P-CSCF), an Interrogating-CSCF (I-CSCF), a Serving-CSCF (S-CSCF), application servers (ASs), a DCMF, a DCSF, and other known types of network devices of the IMS. According to an exemplary embodiment, at least some of external devices 117 of the IMS network may include logic of the IMS data channel priority service, as described herein.

According to some exemplary embodiments, external devices 117 of the IMS network and/or other types of external networks 115, as described herein, may include virtual network devices (e.g., virtualized network functions (VNFs), servers, host devices, application functions (AFs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of end device application services. For example, the end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), hologram, etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, an IoT device, a drone, or another type of UE.

End device 130 may be configured to execute various types of software (e.g., applications, programs, etc.). The number and the types of software may vary among end devices 130. For example, end device 130 may host one or multiple end device applications that may relate to diverse types of application services described in relation to external devices 117. For example, the end device application may pertain to IoT, extreme real-time communications, gaming, voice, video-calling, navigation, ultra-reliable communications, and so forth. The end device application may include a client-side application. End device 130 may include “edge-aware” and/or “edge-unaware” application service clients. For purposes of description, end device 130 is not considered a network device. End device 130 may be implemented as a virtualized device in whole or in part.

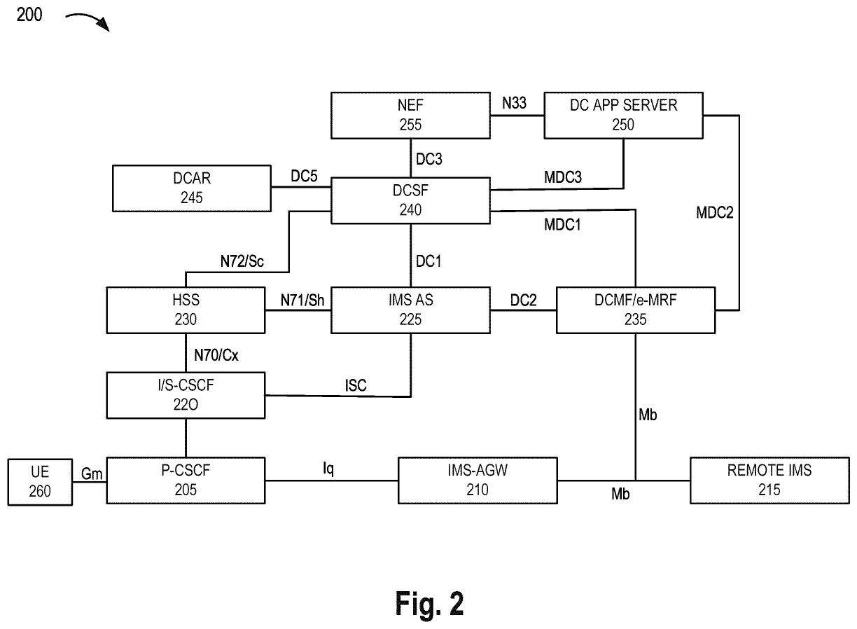

FIG. 2 is a diagram illustrating an exemplary IMS environment 200 that may provide an exemplary embodiment of the IMS data channel priority service. For example, IMS environment 200 may be implemented as a part of external network 115 and external devices 117 depicted in FIG. 1 and described herein.

As illustrated, IMS environment 200 may include a P-CSCF 205, an IMS access gateway (IMS-AGW) 210, a remote IMS 215, an I/S-CSCF 220, an IMS AS 225, an HSS 230, a DCMF/enhanced Media Resource Function (e-MRF) 235, a DCSF 240, a Data Channel Application Repository (DCAR) 245, a Data Channel Application Server (DCAS) 250, and a NEF 255. According to other exemplary embodiments, environment 200 may include different network devices. For example, e-MRF 235 may be implemented instead as an MRF.

FIG. 2 also illustrates exemplary reference point network interfaces, such as N33, MDC3, MDC1, DC5, and so forth. Although not illustrated, a network device of IMS environment 200 may include a service-based network interface, such as an Nimas, an Ndcmf, an Ndcsf, an Nnef, and so forth. According to an exemplary embodiment, at least some of the network interfaces may be modified relative to corresponding network interface defined by a network standardizing body and technical specifications (e.g., 3GPP, GSMA, ETSI, etc.), network interfaces of a proprietary nature, and the like, in a manner that supports an exemplary embodiment of the IMS data channel priority service, as described herein.

P-CSCF 205, IMS-AGW 210, I/S-CSCF 220, IMS AS 225, HSS 230, DCMF/e-MRF 235, DCSF 240, DCAR 245, DCAS 250, and NEF 255 may include logic and perform an operation or provide a function that is in accordance with technical specifications associated with a network standardizing body (e.g., 3GPP, GSMA, ETSI, etc.). For example, P-CSCF 205 may include logic of a proxy server for UE 260, may manage all SIP signaling traffic to and from UE 260 relating to device registration, session establishment, and termination, and may include logic of a SIP user agent, among other functions. I/S-CSCF 220 may manage session states, invoke services, perform session control functionalities, and function as a query point for routing incoming SIP requests within the IMS network. IMS AS 225 may include logic that interacts with DCSF 240 for event notifications, receives data channel control instructions from DCSF 240, interacts with HSS 230 for obtaining data channel IMS AS service specific data, among other functions. HSS 230 may store IMS data channel subscription data, and interact with DCSF 240 and IMS AS 225, among other functions.

DCMF/e-MRF 235 may include logic that provides media resource management, such as bootstrap and application data channel resources, and forwarding of data channel media traffic, among other functions. DCSF 240 may include signaling control function logic that provides data channel control logic. For example, DCSF 240 may receive event reports from IMS AS 225 and may determine whether data channel service is allowed to be provided during the IMS session. DCSF 240 may manage bootstrap data channel and downloads data channel applications from DCAR 245, among other functions. DCAR 245 may include logic that stores verified data channel applications, which may be retrieved by DCSF 240, among other functions. DCAS 250 may host a data channel application, among other functions. NEF 255 may include logic that provides controlled, secure, and efficient access to network capabilities and services by third-party applications, which may include authorization and authentication, policy enforcement, etc., among other functions.

Additionally, P-CSCF 205, IMS-AGW 210, I/S-CSCF 220, IMS AS 225, DCMF/e-MRF 235, and DCSF 240 may each include logic of the IMS data channel priority service and may perform an operation or a function supportive of an exemplary embodiment of the IMS data channel priority service, as described herein. For example, P-CSCF 205, IMS-AGW 210, I/S-CSCF 220, IMS AS 225, DCMF 235, and DCAR 245 may transmit and/or a receive a message associated with the IMS data channel priority service (e.g., the message includes data, such as priority, etc., pertaining to the IMS data channel priority service), establish an IMS session via a data channel with a given priority level, maintain the data channel and the IMS session with the priority level, and the like, as described herein.

Remote IMS 215 may be implemented as an IMS network, which may include similar network devices described and illustrated. UE 260 may be considered an exemplary implementation of end device 130.

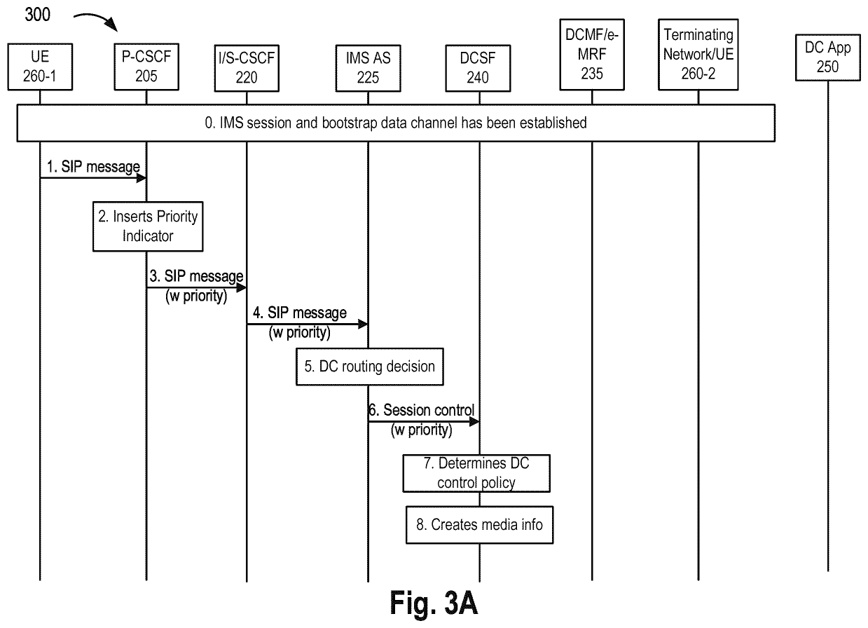

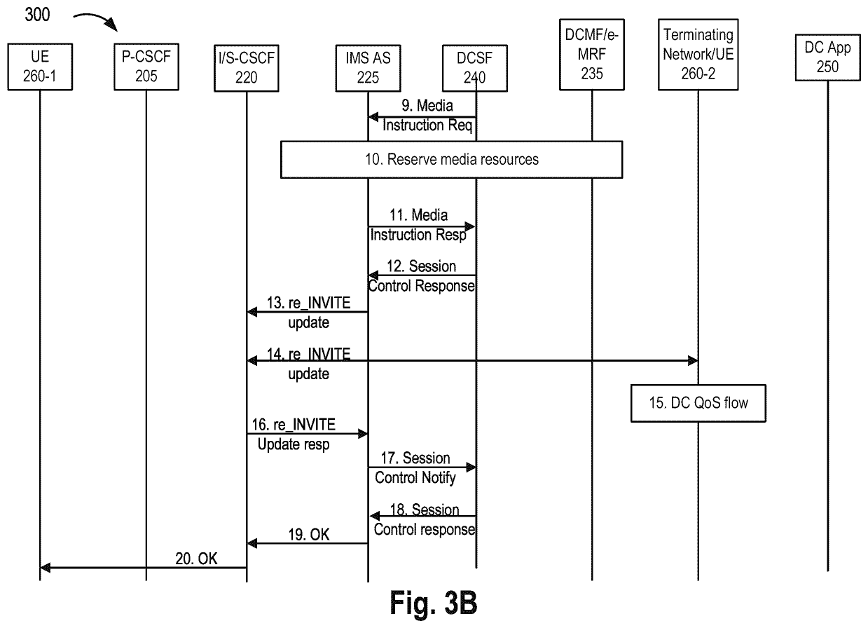

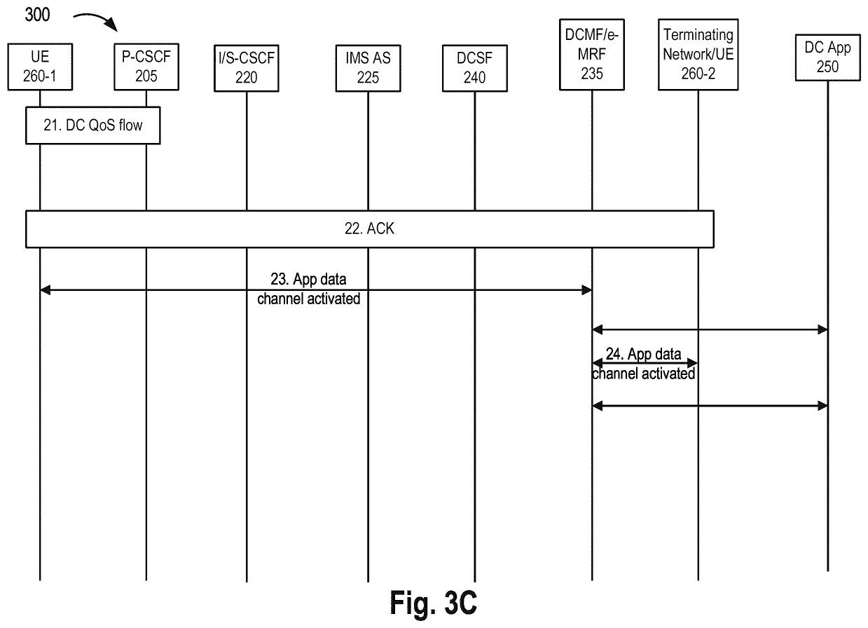

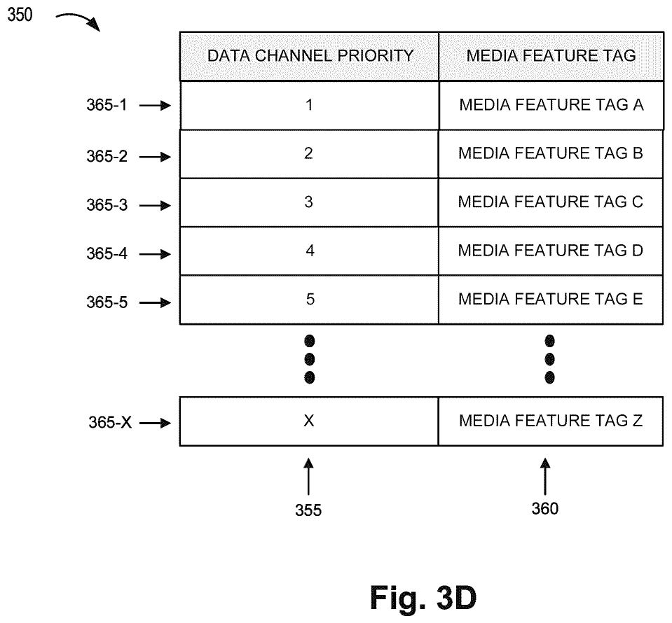

FIGS. 3A-3C are messaging diagrams illustrating an exemplary process 300 of an exemplary embodiment of the IMS data channel priority service involving network devices of IMS environment 200. According to other exemplary embodiments, e-MRF 235 may be replaced with an MRF.

Referring to FIG. 3A, in step (0), a UE 260-1 may establish an IMS session and bootstrap data channel with a UE 260-2. Although not illustrated, step (0) may include UE 260-1 and UE 260-2 each registering on the home IMS network and negotiating the IMS data channel capability. For example, when UE 260-1, which supports IMS data channel, registers on the IMS network, and is allowed to use the IMS data channel (e.g., UE 260-1 has subscribed to IMS data channel, etc.), UE 260-1 may include a media feature tag in the Contact header field of an initial REGISTER request, which allows the home IMS network to discover the IMS data channel capability of UE 260-1. If the IMS network supports IMS data channel, the S-CSCF (e.g., I/S-CSCF 220) may include a Feature-Caps header field indicating its data channel capability in a Hypertext Transfer Protocol (HTTP) 200 OK response. For example, the HTTP 200 OK response may be responsive to an initial and any subsequent REGISTER request, which may be used by UE 260-1 to discover the IMS data channel capability of its home IMS network.

When UE 260-1 initiates an IMS session, UE 260-1, UE 260-1 may include the media feature tag in the Contact header field in an initial INVITE or a re-INVITE request to UE 260-2.

According to an exemplary scenario, the established IMS session between UE 206-1 and 260-2 may be an IMS audio session or an IMS audio/video session, and UE 260-1 may update the IMS session to include an IMS data channel session.

Referring to step (1), UE 260-1 may generate and transmit a SIP message to IMS AS 225 via P-CSCF 205 and I/S-CSCF 220 of an originating IMS network. For example, the SIP message may be a SIP re-INVITE (as performed after the initial IMS session is set up). The SIP re-INVITE may include Session Description Protocol (SDP) information. For example, the SDP information may include an indication of the current IMS session (e.g., audio, audio and video, etc.), an indication of the established bootstrap data channel, and an SDP offer of an application for the IMS data channel. The SDP offer may include a media feature tag.

As illustrated and in contrast to current approaches, in response to receiving the SIP message, in step (2), P-CSCF 205 may insert a priority indicator. For example, P-CSCF 205 may insert the priority indicator in a resource priority header (RPH) of the SIP re-INVITE. According to an exemplary embodiment, P-CSCF 205 may read and identify the media feature tag and insert the appropriate priority indicator for the data channel based on the media feature tag. For example, referring to FIG. 3D, P-CSCF 205 may store data channel priority information.

FIG. 3D is a diagram illustrating exemplary data channel priority information. For example, referring to a table 350 in FIG. 3D, exemplary data channel priority information is illustrated. Table 350 may include a data channel priority field 355 and a media feature tag field 360. As further illustrated, table 350 includes entries 365-1 through 365-X (also referred as entries 365, or individually or generally as entry 365) that each includes a grouping of fields 355 and 360 that are correlated (e.g., a record, etc.). The data channel priority information is illustrated in tabular form merely for the sake of description. In this regard, the data channel priority information may be implemented in a data structure different from a table (e.g., a list, a flat file, etc.), a database, or another type of structure. Additionally, values illustrated in field 355 and field 360 are exemplary. According to other embodiments, the values, strings, or instances of information stored in a field may be different. The number of entries 365 are exemplary for the sake of description purposes.

Data channel priority field 355 may store data that indicates a priority of an IMS data channel. For example, the priority of the IMS data channel may indicate a value that affords a priority, such as an utmost priority, a lowest priority, a moderate priority, a high priority, and so forth, relating to the IMS data channel setup. The data channel priority value may also influence IMS data channel maintenance, termination, and/or other network procedures (e.g., handover, etc.). According to some exemplary embodiments, the priority may be applicable regardless of the state of the IMS network (e.g., extremely congested, no congestion, moderately congested, slightly congested, etc.) and/or amount of available network resources.

Media feature tag field 360 may include data that indicates a media feature tag. For example, the media feature tag may include SDP information indicating a media description pertaining to an IMS data channel.

According to other exemplary embodiments, table 350 may store additional and/or different instances of data channel priority information in support of the IMS data channel priority service, as described herein.

Referring back to FIG. 3A, P-CSCF 205 may compare the media feature tag that is included in the SIP message (e.g., the SIP re-INVITE) and match the media feature tag to a media feature tag indicated in the data channel priority information. P-CSCF 205 may insert the corresponding data channel priority value of the matched media feature tag in the RPH of the SIP message. As an example, P-CSCF 205 may add a sub-field to the RPH having a format of “dc.x” in which “x” indicates the priority value (e.g., a numerical value) for the data channel (“dc”). According to other examples, the priority of the data channel may be expressed in a different manner (e.g., only a numerical value).

In step (3), P-CSCF 205 may transmit the SIP message (with the priority value) to I/S-CSCF 220, which in turn at step (4), transmits the SIP message (with the priority value) to IMS-AS 225. According to some exemplary scenarios, when the IMS network is in a congested state, I/S-CSCF 220 may determine whether to drop the SIP message or not based on the data channel priority value.

In step (5), IMS AS 225 may determine, based on the user subscription data associated with UE 260-1, that a DCSF is to be notified. IMS AS 225 may make a data channel routing decision. For example, IMS AS 225 may select DCSF 240 for UE 260-1 and/or the user based on local configuration or discovery and selection of the DCSF instance via a network repository function (NRF) (not illustrated). According to some exemplary embodiments, the selection of DCSF 240 may be based on the priority of the data channel. According to some exemplary scenarios, when the IMS network is in a congested state, IMS AS 225 may determine whether to drop the SIP message or not based on the data channel priority value. For example, when the value of the data channel priority is relatively high, the SIP message may not be dropped.

In step (6), IMS AS 225 may notify DCSF 240 of the data channel application request by transmitting a session control message, which includes the priority information. For example, IMS AS 225 may transmit an Nimsas_SessionEventControl_Notify request to DCSF 240. The Notify request may include data indicating a media change request event, a session ID, a Media information list, an Event initiator, the IMS data channel priority value, among other types of data (e.g., DC Stream ID, Calling ID, Called ID, etc.). In step (7), in response to receiving and reading/analyzing the session control message, DCSF 240 may determine whether the data channel is to be provided based on the IMS data channel priority value, and if so, a data channel control policy. For example, DCSF 240 may include use of the priority information to determine the data channel control policy for the data channel.

In step (8), DCSF 240 may create media information for both originating and terminating UEs 260-1 and 260-2 that may be required by DCMF/eMRF 235. For example, DCMF/eMRF 235 may reserve originating and terminating media information, which may be used to receive the request for application downloading by DCMF/eMRF 235.

Referring to FIG. 3B, in step (9), DCSF 240 may transmit the media instruction to IMS AS 225. For example, DCMF/eMRF 235 may generate and transmit an Nimsas_MediaControl_MediaInstructionResponse message that includes the session ID, and the media instruction set. In step (10), IMS AS 225 may request DCMF/e-MRF 235 to reserve media resources for both originating and terminating side media resources, and DCMF/e-MRF 235 may allocate resources. IMS AS 225 may select DCMF/e-MRF 235 based on local configuration or discovery and selection of the MF or MRF via the NRF, as described herein. Each media termination may include information required to allocate resources in both Mb and MDC1 interfaces. DCMF/e-MRF 235 may respond with negotiated data channel media resource information to IMS AS 225. If the e-MRF is used, IMS AS 225 may use Mr′/Cr interfaces to reserve the data channel resources.

In step (11), IMS AS 225 may transmit a media instruction response to DCSF 240. For example, the response may be implemented as an Nimsas_MediaControlInstructionResponse that includes result information (e.g., the atomic success result of operation) and media resource information (e.g., the negotiated data channel media resource information). In step (12), DCSF 240 may store the media resource information, and transmit a session control response to IMS AS 225, which responds to the session control notify message of step (6). In steps 13 and 14, IMS AS 225 may send a SIP re-INVITE to terminating network/UE 260-2 via I/S-CSCF 220. The SIP re-INVITE may include the updated SDP offer for the application data channel adding the media information of DCMF/e-MRF 235. In step (15), terminating network/UE 260-2 may execute a QoS procedure for the data channel, and in step (16) provides a SIP re-INVITE response with an SDP answer to IMS AS 225 via I/S-CSCF 220. For example, SIP re-INVITE response may include a data channel answer and a data channel application answer, for example.

In step (17), IMS AS 225 may notify DCSF 240 of the successful session establishment event. For example, the session control notify message may be implemented as an Nimsas_SessionEventControl Notify message that includes data indicating the session establishment success event, the session ID, and the media info list, for example. In step (18), DCSF 240 responds to the notification. In steps 19 and 20, an HTTP 200 OK message may be forwarded to UE 260-1 via I/S-CSCF 220 and P-CSCF 205, which indicates that the data channel has been established.

Referring to FIG. 3C, in step (21), P-CSCF 205 may execute a QoS procedure for the data channel, and in step (22), an acknowledgement between UEs 260-1 and 260-2 may be executed. In steps 23 and 24, the application data channels may be activated, which may include request messages to DCMF/e-MRF 235 for a data channel application or an application list. The data channel application may be downloaded by UE 260-1 and/or UE 260-2.

FIGS. 3A-3C are diagrams illustrating process 300 according to an exemplary scenario. According to other exemplary scenarios, an IMS session and an IMS data channel session may be established simultaneously. According to yet other exemplary scenarios, UE 260-2 may initiate the SIP message of step (1) instead of UE 260-1. According to still other exemplary scenarios, process 300 may not involve multiple UEs 260. Rather, UE 260 may establish an IMS data channel session with an application server (e.g., a data channel application server). The application server may reside in the IMS network or external from the IMS network.

The messages illustrated in FIGS. 3A-3C are exemplary. Additionally, according to other exemplary scenarios, an operation or a function performed by a network device of the IMS network, may be different than the operation or the function described.

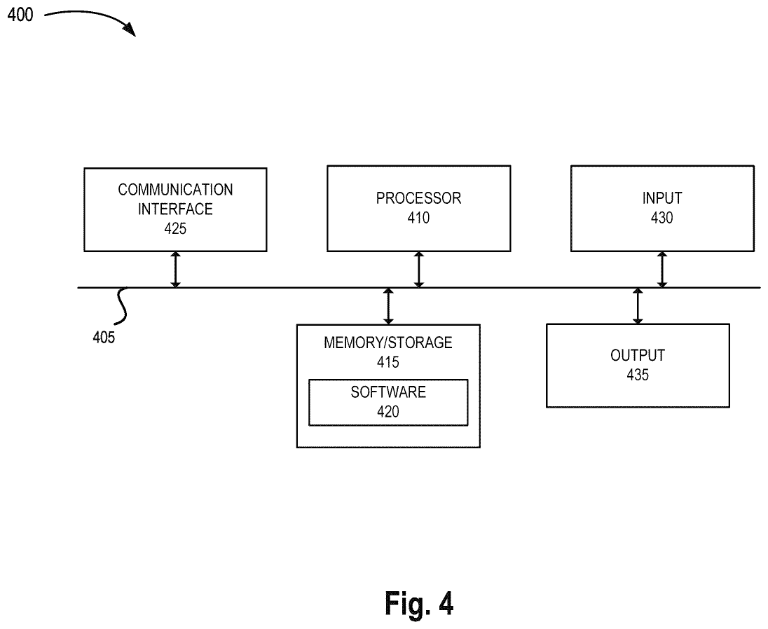

FIG. 4 is a diagram illustrating exemplary components of a device 400 that may be included in one or more of the devices described herein. For example, device 400 may correspond to access device 107, end device 130, core device 122, and external device 117, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), ASICs, controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to external device 117, software 420 may include an application that, when executed by processor 410, provides a function and/or a process of the IMS data channel priority service, as described herein. According to another example, with reference to end device 130, software 420 may include an application that, when executed by processor 410, provides a function and/or a process of the IMS data channel priority service, as described herein. Software 420 may also include firmware, middleware, microcode, hardware description language (HDL), and/or another form of instruction. Software 420 may also be virtualized. Software 420 may further include an operating system (e.g., Windows, Linux, Android, proprietary, etc.), such as operating system 204. Software 420 may include applications, libraries, AI/ML models, and the like.

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function, an operation, or a process described herein. Alternatively, for example, according to other implementations, device 400 may be configured to perform a function, an operation, or a process described herein based on the execution of hardware (processor 410, etc.).

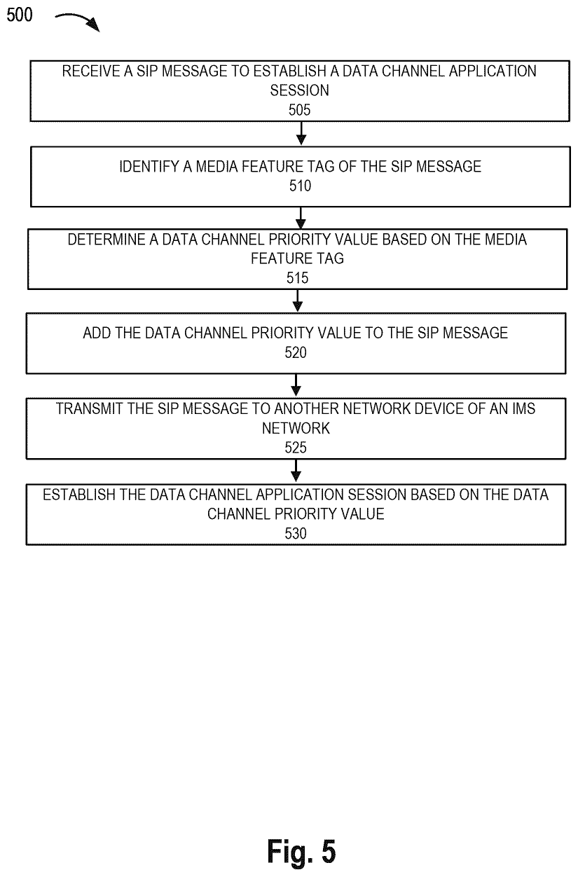

FIG. 5 is a flow diagram illustrating an exemplary process 500 of an exemplary embodiment of the IMS data channel priority service. According to an exemplary embodiment, external device 117 of an IMS network may perform steps of process 500. For example, external device 117 may include a P-CSCF (e.g., P-CSCF 205). According to an exemplary implementation, a processor may execute software to perform a step (in whole or in part) of process 500, as described herein. Alternatively, a step (in whole or in part) may be performed by execution of only hardware.

In block 505, the P-CSCF may receive a SIP message to establish a data channel application session. The SIP message may include a media feature tag pertaining to the data channel application. The SIP message may be an INVITE or a re-INVITE from end device 130 to another end device 130.

In block 510, the P-CSCF may identify the media feature tag of the SIP message. For example, the P-CSCF may read a resource priority header of the SIP message.

In block 515, the P-CSCF may determine a data channel priority value based on the media feature tag. For example, the P-CSCF may perform a lookup in data channel priority information, and match the media feature tag to a media feature tag of the data channel priority information. The P-CSCF may select the data channel priority value that correlates to the media feature tag of the data channel priority information.

In block 520, the P-CSCF may add the data channel priority value to the SIP message. For example, the P-CSCF may add the data channel priority value to the resource priority header.

In block 525, the P-CSCF may transmit the SIP message to another network device of an IMS network. For example, the P-CSCF may transmit the SIP message to an IMS-AS via an S-CSCF of the IMS network.

In block 530, an I/S-CSCF, an IMS AS, a DCSF, and a DCMF/MRF may establish the data application session based on the data channel priority value. For example, the IMS AS may provide session event control information, which may include the data channel priority value, to the DCSF. The DCSF may use the data channel priority value to determine the data channel control policy. Additionally, for example, the IMS AS and the DCMF/MRF may allocate media resources based on the data channel priority value.

FIG. 5 illustrates an exemplary process 500 of the IMS data channel priority service, however, according to other exemplary embodiments, the IMS data channel priority service may perform additional operations, fewer operations, and/or different operations than those illustrated and described in relation to FIG. 5.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the processes illustrated in FIG. 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device of a network, a message to establish a data channel application session;
identifying, by the network device, a media feature tag included in the message;
determining, by the network device, a data channel priority value based on the media feature tag;
adding, by the network device, the data channel priority value to the message;
transmitting, by the network device to another network device of the network, the message; and
establishing, by the network device, the data channel application session based on the data channel priority value.

2. The method of claim 1, wherein the adding includes adding the data channel priority value to a resource priority header of the message.

3. The method of claim 1, wherein the determining includes correlating the media feature tag to the data channel priority value, which is included in information stored by the network device and indicates correlations between different media feature tags and different data channel priority values.

4. The method of claim 1, wherein the data channel priority value indicates a priority to network resources for an Internet Protocol Multimedia Subsystem (IMS) data channel in the network.

5. The method of claim 1, wherein the other network device includes an Internet Protocol Multimedia Subsystem (IMS) application server of the network.

6. The method of claim 1, wherein the message includes a Session Initiation Protocol (SIP) message, and wherein the media feature tag is included in a Session Description Protocol offer.

7. The method of claim 1, wherein the establishing comprises:
using the data channel priority value to select a data channel control policy for a data channel to be set up in the network.

8. The method of claim 1, wherein the network device includes a Proxy-Call Session Control Function (P-CSCF).

9. A network device comprising:
a processor, wherein the processor is configured to:
receive a message to establish a data channel application session via a network of the network device;
identify a media feature tag included in the message;
determine a data channel priority value based on the media feature tag;
add the data channel priority value to the message;
transmit to another network device of the network, the message; and
establish the data channel application session based on the data channel priority value.

10. The network device of claim 9, wherein when to add, the processor is further configured to:
add the data channel priority value to a resource priority header of the message.

11. The network device of claim 9, wherein when to determine, the processor is further configured to:
correlate the media feature tag to the data channel priority value, which is included in information stored by the network device and indicates correlations between different media feature tags and different data channel priority values.

12. The network device of claim 9, wherein the data channel priority value indicates a priority to network resources for an Internet Protocol Multimedia Subsystem (IMS) data channel in the network.

13. The network device of claim 9, wherein the other network device includes an Internet Protocol Multimedia Subsystem (IMS) application server.

14. The network device of claim 9, wherein the message includes a Session Initiation Protocol (SIP) message, and wherein the media feature tag is included in a Session Description Protocol offer.

15. The network device of claim 9, wherein to establish, the processor is further configured to:
use the data channel priority value to select a data channel control policy for a data channel to be set up in the network.

16. The network device of claim 9, wherein the network device includes a Proxy-Call Session Control Function (P-CSCF).

17. A non-transitory computer-readable storage medium storing instructions executable by a processor of a network device of a network, wherein the instructions are configured to:
receive a message to establish a data channel application session;
identify a media feature tag included in the message;
determine a data channel priority value based on the media feature tag;
add the data channel priority value to the message;
transmit to another network device of the network, the message; and
establish the data channel application session based on the data channel priority value.

18. The non-transitory computer-readable storage medium of claim 17, wherein the instructions to add are further configured to:
add the data channel priority value to a resource priority header of the message.

19. The non-transitory computer-readable storage medium of claim 17, wherein the instructions to determine are further configured to:
correlate the media feature tag to the data channel priority value, which is included in information stored by the network device and indicates correlations between different media feature tags and different data channel priority values.

20. The non-transitory computer-readable storage medium of claim 17, wherein the data channel priority value indicates a priority to network resources for an Internet Protocol Multimedia Subsystem (IMS) data channel in the network.
